(19) United States
(12) Patent Application Publication
(10) Pub. No.: US 2026/0241284 A1
(43) Pub. Date: Aug. 20, 2026

(54) Virtual Object Control Method and Apparatus, Device, and Storage Medium

(71) Applicant: Tencent Technology ( Shenzhen ) Company Limited, Shenzhen (CN)

(72) Inventors: Jiayu Wang, Shenzhen (CN); Yusheng Mao, Shenzhen (CN)

(21) Appl. No.: 19/640,840

(22) Filed: Apr. 7, 2026

Related U.S. Application Data
(63) Continuation of application No. PCT/CN2025/097916, filed on May 29, 2025.

(30) Foreign Application Priority Data
Jul. 19, 2024 (CN) 202410973499.8

(51) Int. Cl. A63F 13/55; A63F 13/52; A63F 13/537

(52) U.S. Cl. CPC A63F 13/55; A63F 13/52; A63F 13/537

(57) ABSTRACT

This application is related to virtual object control. A method comprises: displaying a virtual scene, the virtual scene including a virtual object; controlling, in response to a displacement operation for the virtual object, the virtual object to move in the virtual scene, the displacement operation being configured for implementing a movement process of moving the virtual object from a first position to a second position in the virtual scene; receiving a first skill release operation for the virtual object in the movement process, the first skill release operation being configured for controlling the virtual object to release a directional first skill, and the first skill release operation being received when the virtual object moves to a third position in the virtual scene; and controlling the virtual object to release the first skill based on the second position.

### RELATED APPLICATIONS

This application claims priority to PCT/CN2025/097916, filed on May 29, 2025, which claims priority to Chinese Patent Application No. 202410973499.8, filed with the China National Intellectual Property Administration on July 19, 2024 and entitled "VIRTUAL OBJECT CONTROL METHOD AND APPARATUS, DEVICE, AND STORAGE MEDIUM", each of which is incorporated herein by reference in its entirety.

### FIELD OF THE TECHNOLOGY

This application relates to the field of computer technologies, and in particular, to a virtual object control method and apparatus, a device, and a storage medium.

### BACKGROUND

A displacement skill refers to a skill in a game that causes a main character of a player or a related character to change its absolute position in a coordinate system of the game.

In the related art, a caching mechanism is set in a displacement process. In the displacement process, a game character receives a skill release operation inputted by a user, and obtains a position of the game character when the skill release operation is received. When reaching a displacement end position, the game character releases a skill based on the skill release operation inputted in the displacement process and the position of the game character when the skill release operation is received.

However, due to a fast displacement speed, the user cannot accurately determine the position of the game character when inputting the operation. As a result, the released skill is not the skill that the user expects to release, leading to inaccurate skill output.

### SUMMARY

This application provides a virtual object control method and apparatus, a device, and a storage medium, to improve skill release accuracy and improve human-computer interaction efficiency. Technical solutions provided in the examples of this application are as follows.

According to one aspect of the examples of this application, a virtual object control method is provided. The method is performed by a terminal device, and the method includes: displaying a virtual scene, the virtual scene including a virtual object; controlling, in response to a displacement operation for the virtual object, the virtual object to move in the virtual scene, the displacement operation being configured for implementing a movement process of moving the virtual object from a first position to a second position in the virtual scene; receiving a first skill release operation for the virtual object in the movement process, the first skill release operation being configured for controlling the virtual object to release a directional first skill, and the first skill release operation being received when the virtual object moves to a third position in the virtual scene, the third position being a position in the movement process in which the virtual object moves from the first position to the second position in the virtual scene; and controlling the virtual object to release the first skill based on the second position.

According to one aspect of the examples of this application, a virtual object control apparatus is provided. The apparatus includes: an object display module, configured to display a virtual scene, the virtual scene including a virtual object; a movement control module, configured to control, in response to a displacement operation for the virtual object, the virtual object to move in the virtual scene, the displacement operation being configured for implementing a movement process of moving the virtual object from a first position to a second position in the virtual scene; an operation receiving module, configured to receive a first skill release operation for the virtual object in the movement process, the first skill release operation being configured for controlling the virtual object to release a directional first skill, and the first skill release operation being received when the virtual object moves to a third position in the virtual scene, the third position being a position in the movement process in which the virtual object moves from the first position to the second position in the virtual scene; and a skill control module, configured to control the virtual object to release the first skill based on the second position.

According to one aspect of the examples of this application, a terminal device is provided. The terminal device includes a processor and a memory, the memory having a computer program stored therein, the computer program being loaded and executed by the processor to implement the foregoing virtual object control method.

According to one aspect of the examples of this application, a computer-readable storage medium is provided. The computer-readable storage medium has a computer program stored therein, the computer program being loaded and executed by a processor to implement the foregoing virtual object control method.

According to one aspect of the examples of this application, a computer program product is provided. The computer program product includes a computer program, the computer program being loaded and executed by a processor to implement the foregoing virtual object control method.

The technical solutions provided in the examples of this application may bring the following beneficial effects. A manner for optimizing skill release in a movement process of a virtual object is provided. Through a displacement operation for the virtual object, the virtual object is controlled to move from a first position to a second position in a virtual scene. In the movement process, when the virtual object moves to a third position, a first skill release operation for the virtual object can be received, and the virtual object can be controlled to release a first skill based on the second position. Because the second position is an end position of the movement process, and the first skill release operation is an input operation in the movement process, this manner of controlling the virtual object to release the first skill based on the second position enables an output to be calculated based on the end position of the movement process and the input operation in the movement process (e.g., the first skill is released based on the second position). In one aspect, if the user cannot accurately determine a position of the virtual object when performing the input operation, the first skill finally released is a skill released based on the end position of the movement process, conforming to the user's expectation. In another aspect, compared with the related art, in which an output is calculated based on a position during an input operation and an input operation in the movement process, which causes a problem of inaccurate skill output, in the method, an output can be calculated based on the end position in the movement process, which improves skill release accuracy, thereby improving human-computer interaction efficiency. In a further aspect, the first skill released in this manner better conforms to the user's expectation, thereby improving game satisfaction for the user.

### BRIEF DESCRIPTION OF THE DRAWINGS

FIG. 1 is a schematic diagram of a solution implementation environment according to an example of this application.

FIG. 2 is a schematic diagram of a drag operation according to the related art.

FIG. 3 is a schematic diagram of release of a direction-targeted skill and a position-targeted skill according to the related art.

FIG. 4 is a schematic diagram of skill output according to the related art.

FIG. 5 is a schematic diagram of comparison between an example of this application and an example of the related art according to an example of this application.

FIG. 6 is a flowchart of a virtual object control method according to an example of this application.

FIG. 7 is a schematic diagram of release of a direction-targeted skill according to an example of this application.

FIG. 8 is a schematic diagram of release of a position-targeted skill according to an example of this application.

FIG. 9 is a flowchart of output corresponding to a user input operation according to an example of this application.

FIG. 10 is a flowchart of a virtual object control method according to another example of this application.

FIG. 11 is a flowchart of a virtual object control method according to another example of this application.

FIG. 12 is a block diagram of a virtual object control apparatus according to an example of this application.

FIG. 13 is a structural block diagram of a computer device according to an example of this application.

### DETAILED DESCRIPTION

Before the examples of this application are described, for ease of understanding this solution, terms appearing in this solution are explained below.

1. Virtual scene: It is an environment displayed (or provided) when an application is running on a terminal device. The virtual scene may be a simulated world of a real world, or may be a semi-simulated semi-fictional three-dimensional world, or may be an entirely fictional three-dimensional world. The virtual scene may be any one of a two-dimensional virtual scene, a 2.5-dimensional virtual scene, or a three-dimensional virtual scene. In some examples, the virtual scene is further configured for virtual scene battles between at least two virtual objects, and the virtual scene has virtual resources that can be used by the at least two virtual objects. In some examples, the virtual scene includes an open-world virtual scene in which at least one level mission exists, and a virtual object can freely choose when and how to complete the mission.

2. Virtual object: It refers to a movable object and an immovable object in a virtual scene. The movable object may be at least one of a virtual character, a virtual animal, or an animated character. The immovable object may be at least one of a virtual building, a virtual plant, or virtual terrain. In some examples, when the virtual scene is a three-dimensional virtual scene, the virtual object may be a three-dimensional virtual model. Each virtual object in the three-dimensional virtual scene has its own shape and volume, occupying a part of space in the three-dimensional virtual scene. In some examples, the virtual object is a three-dimensional character constructed based on a three-dimensional human skeleton technology. The virtual object achieves different appearances by wearing different skins. In some implementations, the virtual object may alternatively be implemented by using a 2.5-dimensional model or 2-dimensional model. This is not limited in the examples of this application. For example, according to different manners of controlling a virtual object, the virtual object may be divided into a user-controlled virtual object and a server-controlled virtual object. The user-controlled virtual object is a movable object in the virtual scene that is controlled by a client. The server-controlled virtual object is a virtual object controlled by an automatic control algorithm or an artificial intelligence program on the client or the server. The server-controlled virtual object includes a movable object and an immovable object in the virtual scene. For example, the immovable object may respond to or affect an activity of the movable object. For example, the movable object may destroy the immovable object, or when the movable object enters the immovable object, the movable object enters an invisible state. For example, the virtual object in this application is a virtual object controlled by the client.

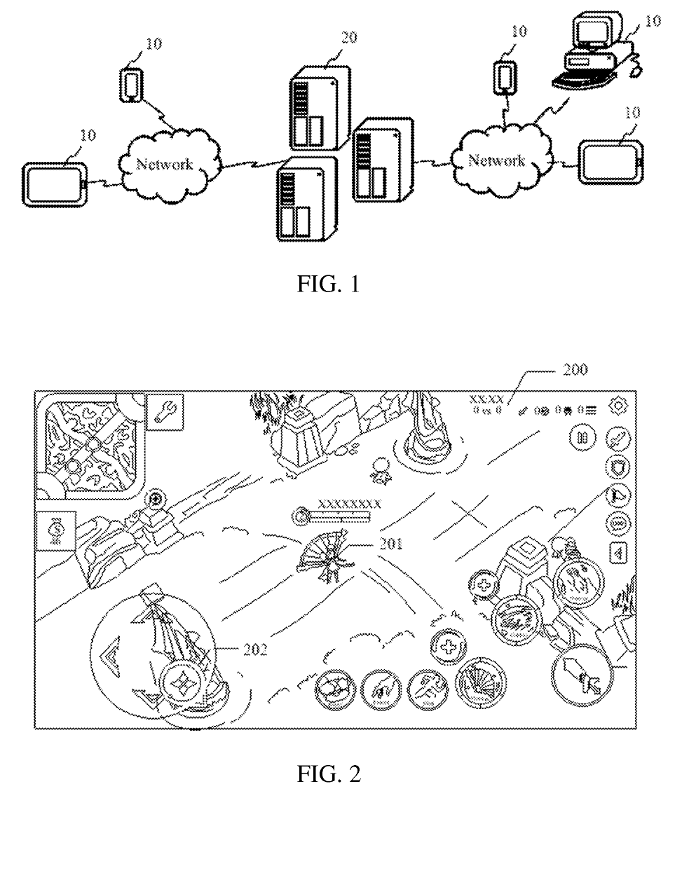

FIG. 1 is a schematic diagram of a solution implementation environment according to an example of this application. The solution implementation environment may be implemented as a control system for a virtual object. The solution implementation environment may include: a terminal device 10 and a server 20.

One or more terminal devices 10 may be provided. The terminal device 10 may be at least one electronic device such as a mobile phone, a tablet computer, a game console, an e-book reader, a multimedia playback device, a wearable device, a personal computer (PC), and an in-vehicle terminal. A client of a target application (for example, a game application) may be installed in the terminal device 10. In some examples, the target application may be an application that needs to be downloaded and installed, or may be a click/tap-to-use application. This is not limited in this example of this application.

In the examples of this application, the target application may be a game application, including at least one of a shooting application, a racing application, or a multiplayer online battle arena game. This is not limited in this application. In some examples, the target application can provide a virtual scene for a virtual object controlled and operated by a user to perform an activity in the virtual scene, including at least one of walking, jumping, crawling, fighting, or shooting. For example, the target application may be a multiplayer online battle arena (MOBA) game, a shooting game, a multiplayer gunfight survival game, a virtual-reality (VR) shooting application, an augmented reality (AR) application, a three-dimensional map program, a social application, or an interactive entertainment application. In addition, for different applications, forms or shapes of virtual objects provided by the applications may also be different, and their corresponding functions may also be different. These may be designed according to actual requirements. This is not limited in this example of this application. In some examples, a client of the application is running in the terminal device 10. In some examples, the application is an application developed based on a three-dimensional virtual scene engine. For example, the virtual scene engine is a Unity engine, and the virtual scene engine can construct at least one of a three-dimensional virtual scene, a virtual object, and a virtual item, bringing more immersive gaming experience to the user.

The virtual scene refers to a scene created for a virtual object to perform an activity (such as in a game arena), including at least one of a virtual house, a virtual island, or a virtual map.

The virtual object refers to at least one of a virtual character, a virtual vehicle, and a virtual item controlled by a user account in the target application. This is not limited in this application. Using the target application being a game application as an example, the virtual object refers to a game character controlled by the user account in the game application. The virtual object may be in a form of a character, which may be an animal or a cartoon, or may be in other forms. This is not limited in this example of this application. In some examples, the virtual object is a virtual vehicle in the virtual scene, including at least one of a virtual car, a virtual hot air balloon, or a virtual motorcycle, which is a virtual item that can be controlled by the user.

The server 20 is configured to provide a backend service for the client of the target application installed and running on the terminal device 10. For example, the server 20 may be a backend server of the game application. The server 20 may be a server, a server cluster including a plurality of servers, or a cloud computing service center. In some examples, the server 20 simultaneously provides backend services for target applications in a plurality of terminal devices 10. The terminal device 10 and the server 20 may communicate with each other through a network.

In the related art, tap is a common operation manner in a game application, and a specific operation manner thereof refers to an action of vertically pressing on a screen of a terminal device without performing at least one operation of sliding or dragging on the screen of the terminal device, and vertically lifting off the screen of the terminal device. Drag is also a common operation manner in a game application, and a specific operation manner thereof refers to an action of pressing on a screen of a terminal device, moving the hand parallel to the screen of the terminal device to slide or drag by a distance, and then lifting off the screen. For example, in the MOBA game, due to the use of a dual-joystick control mode for the virtual object, where the left hand controls position movement of the virtual object, and the right hand controls skill release of the virtual object, tap operations are often used to release some skills that do not require target selection, position selection, or direction selection. For example, skills including at least one of increasing an attack speed of the virtual object or increasing health points of the virtual object are often implemented through tap operations.

For a drag operation, an action of the drag operation is actually a selection operation relative to an origin (a position of the virtual object in the virtual scene). Referring to FIG. 2, a virtual scene is displayed in a virtual scene picture 200. The virtual scene includes a virtual object 201. The virtual object 201 is a game character controlled by a user account in a game application. The virtual scene picture further displays a drag control 202. The drag control 202 is configured to select a skill release direction and a skill release distance. The drag control 202 in FIG. 2 drags a skill joystick in a lower-right direction, that is, selects the lower-right direction to release a skill. In fact, in a rectangular coordinate system corresponding to the virtual scene, a (1, –1) direction based on an origin is selected to release the skill. The rectangular coordinate system corresponding to the virtual scene is a rectangular coordinate system that uses a position of the virtual object in the virtual scene as the origin, a length of the virtual scene picture as an x-axis, and a width of the virtual scene picture as a y-axis.

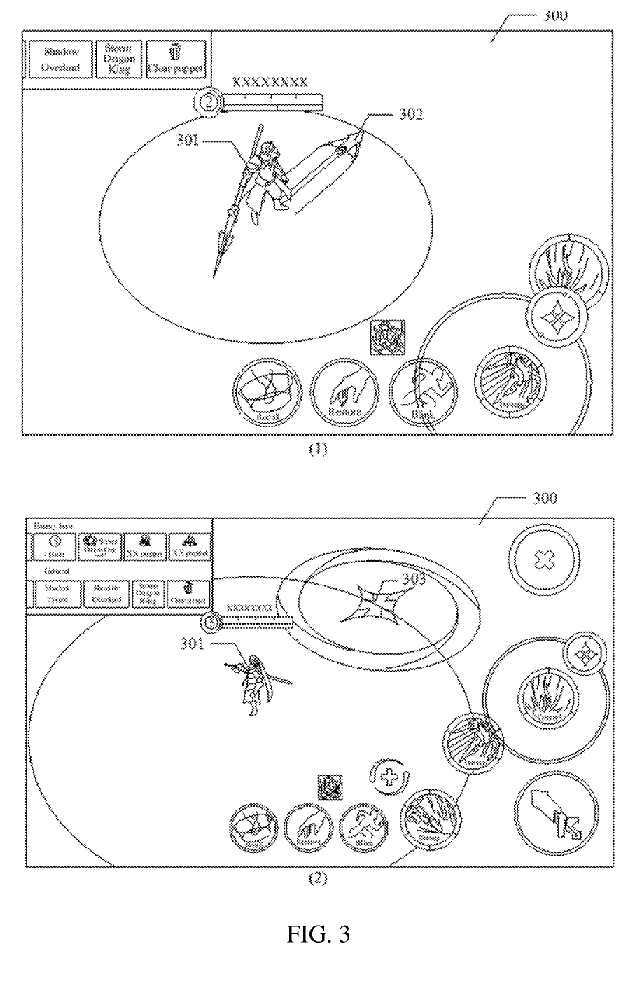

Skills in the MOBA game are highly specific and may not be fully classified. Therefore, the skills are simply classified based on current market characteristics. The skills based on the drag operation may be simply classified into direction-targeted skills and position-targeted skills. For example, FIG. 3(1) is a schematic diagram of release of a direction-targeted skill, and FIG. 3(2) is a schematic diagram of release of a position-targeted skill. In FIG. 3(1), a virtual object 301 is displayed in a virtual scene picture 300. The virtual object 301 selects a (1, 1) direction 302 in a rectangular coordinate system based on an origin to release a skill. Therefore, the direction-targeted skill is a skill of selecting a relative direction, and the relative direction is a direction relative to the origin in the rectangular coordinate system in which the virtual object is located. In this process, the game application saves a vector value (a relative value) inputted by the user, and the vector value is a direction relative to the origin. In FIG. 3(2), a virtual object 301 is displayed in a virtual scene picture 300, and the virtual object 301 selects a position 303 in a rectangular coordinate system based on an origin to release a skill. Therefore, the position-targeted skill is a skill of selecting a distance while selecting a relative direction. In this process, the game application saves a coordinate (an absolute value), and the coordinate is a vector value based on the origin.

After receiving an input operation inputted by the user, the client of the game application on the terminal device converts the input operation into an output result based on a pre-designed program. Generally, an output is calculated based on a position of the virtual object in the virtual scene when the input operation is performed, making the concept of input strongly correlated with a "current" position.

For a displacement skill, the displacement skill refers to a skill in a game application that causes a main virtual object of a user account or a related virtual object to change its absolute position in a coordinate system of the game application. The displacement skill includes, but is not limited to, at least one of the following characteristics: linear displacement, curved displacement, variable-speed displacement, constant-speed displacement, teleportation, or non-teleportation. In fact, generally, to improve gaming experience, the displacement skill is often designed to involve a process with a longer distance, a shorter duration, and a higher displacement speed. However, this design results in the following outcome: in a displacement process, due to the excessive displacement speed and inherent limitations of human physiological conditions, the user cannot accurately determine a position of the virtual object in the displacement process. For example, in the displacement process, the user cannot determine, at each time point, at least one type of information of the position of the virtual object or relative positions of other virtual objects.

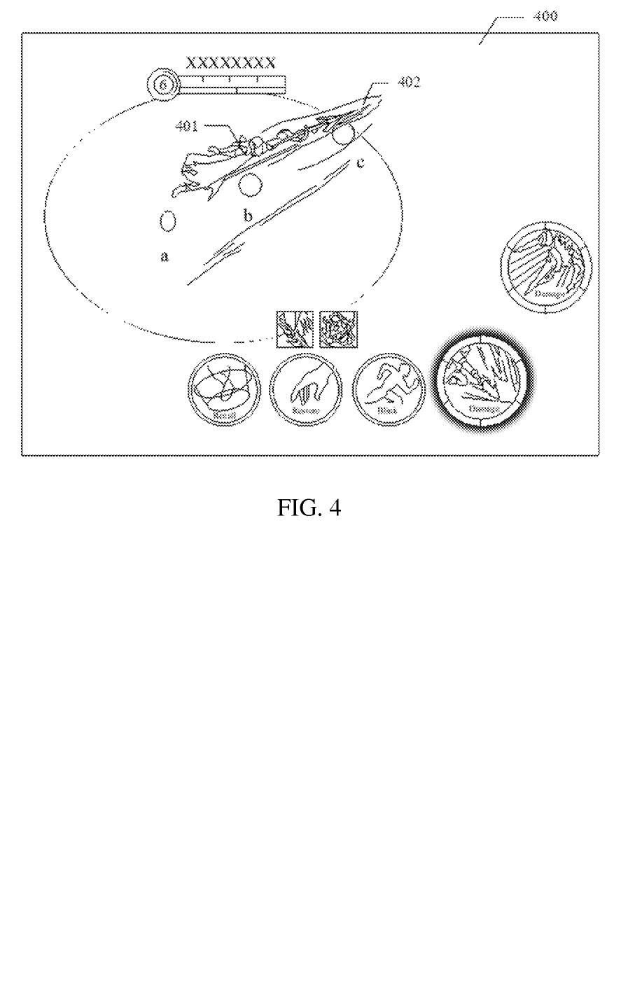

Due to the presence of a caching mechanism in the displacement process, the user may often generate output based on this. The caching mechanism is explained herein. The caching mechanism is configured for storing various data in an operation process of the virtual object, so that during gameplay, in consideration of balance and realism, when the virtual object performs an operation, the virtual object is temporarily prevented from performing other operations. For example, if an action of the virtual object is throwing a ball, the virtual object cannot perform an operation such as picking up an axe in the ball throwing process. The operation of picking up an axe can be performed only after the ball throwing action ends, and this setting may be referred to as a pre-action or post-action. If the user performs an input operation during the pre-action or post-action period, generally, the program saves the action of the user, and implements output corresponding to the input operation received during the pre-action or post-action after the period ends. For example, if the pre-action for throwing a stone is one second, the virtual object may perform an operation of picking up an axe at 0.99 seconds. Without a caching mechanism, the virtual object may not respond to the inputted operation of picking up an axe, which may bring a highly negative gaming experience to the user. Therefore, operations of the user during the pre-action and post-action periods are often cached, and inputs during the pre-action or post-action periods are responded to when the pre-action or post-action ends. Therefore, the user may also perform the input operation in the displacement process. However, in this case, determining of the position of the virtual object by the user is inaccurate, and it is found in product practice that the user expects the input operation in the displacement process to be responded to at a displacement end position. As shown in FIG. 4, a virtual object 401 is displayed in a virtual scene picture 400. The virtual object 401 selects a direction 402 and moves from a point a to a point c. When the virtual object 401 moves to a point b, the user performs an input operation. Based on the solution in the related art, an output needs to be calculated based on the point b when the virtual object 401 reaches the point c. However, the user expects to calculate the output based on the point c. As a result, skill output in the related art is inaccurate and does not conform to the user's actual expectation.

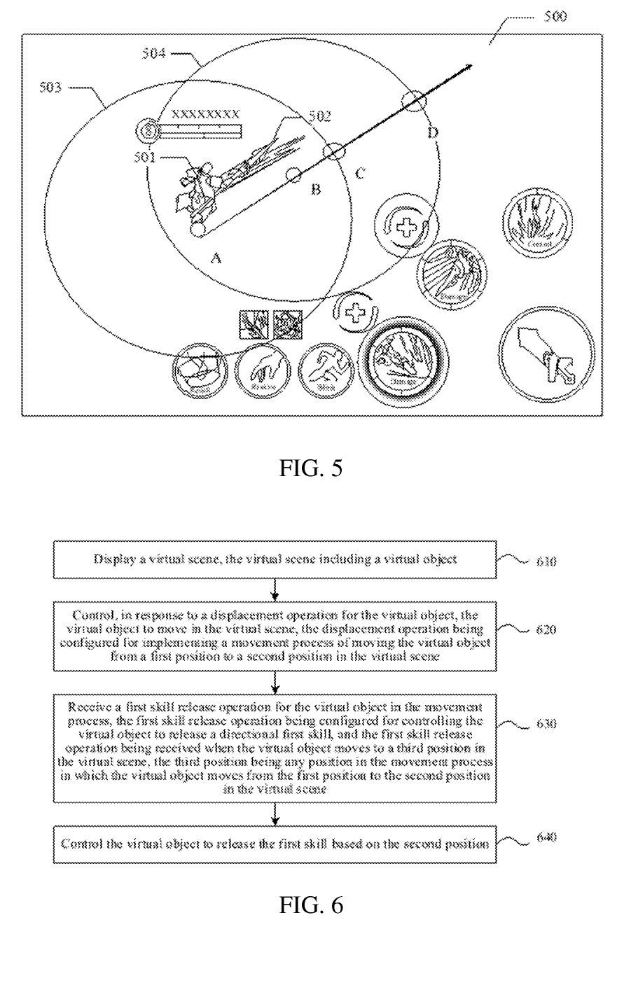

A schematic diagram of comparison between this example of this application and an example of the related art is shown in FIG. 5. A virtual object 501 is displayed in a virtual scene picture 500, and the virtual object 501 selects a direction 502 for displacement. A point A is a position at which the user inputs a skill release operation in the displacement process of the virtual object 501, a point B is an end position of the displacement process, a skill circle 503 is a range of a skill released based on the point A, with a radius being a skill release distance and a skill circle 504 is a range of a skill released based on the point B. A point C is an output point of skill release based on the point A when the displacement process ends in the related art, and a point D is an output point of skill release based on the point B when the displacement process ends in this example of this application.

FIG. 6 is a flowchart of a virtual object control method according to an example of this application. Operations of the method may be performed by a terminal device, a client of a target application may be installed and running on the terminal device, and the target application may be a game application. The method may include at least one of the following operations 610 to 640.

Operation 610: Display a virtual scene, the virtual scene including a virtual object.

The terminal device displays a virtual scene picture, a virtual scene is displayed in the virtual scene picture, and the virtual scene includes a virtual object. In some examples, the virtual object is in a match state.

The virtual scene picture refers to a picture of the virtual scene observed from the perspective of the virtual object. The perspective of the virtual object may be a third-person view of the virtual object, or may be a first-person view of the virtual object. In some examples, the virtual scene picture refers to a display picture presented to the user on the terminal device. The virtual scene picture may be a picture obtained by a virtual camera from the virtual scene. In a possible implementation, the virtual camera obtains the virtual scene picture from the third-person view of the virtual object. In some examples, the virtual camera is disposed obliquely above the virtual object, and the client observes the virtual scene through the virtual camera with the virtual object as a center, and obtains and displays the virtual scene picture with the virtual object as the center. In another possible implementation, the virtual camera obtains the virtual scene picture from the first-person view of the virtual object. In some examples, the virtual camera is disposed right in front of the virtual object, and the client observes the virtual scene through the virtual camera from the perspective of the virtual object, and obtains and displays the virtual scene picture from the first-person view of the virtual object. In addition, in an example, a placement position of the virtual camera is adjustable in real time. In some examples, the user may adjust the position of the virtual camera through a touch operation for a display interface of the terminal device, to obtain virtual scene pictures corresponding to different positions. For example, the user may adjust the position of the virtual camera by dragging the virtual scene picture. For another example, the user may adjust the position of the virtual camera by clicking/tapping a position in a map presentation control, and using the position as an adjusted position of the virtual camera. The map presentation control refers to a control configured for presenting a global map in the game application.

Operation 620: Control, in response to a displacement operation for the virtual object, the virtual object to move in the virtual scene, the displacement operation being configured for implementing a movement process of moving the virtual object from a first position to a second position in the virtual scene.

The displacement operation for the virtual object is triggered by the user, and is configured for controlling the virtual object to perform an operation of position movement in the virtual scene. After receiving the displacement operation for the virtual object, the client of the terminal device controls the virtual object to move from the first position to the second position in the virtual scene.

The displacement operation for the virtual object includes at least one of the following: an operation configured for implementing linear displacement, an operation configured for implementing curved displacement, an operation configured for implementing variable-speed displacement, an operation configured for implementing constant-speed displacement, an operation configured for implementing teleportation, and an operation configured for implementing non-teleportation displacement.

In some examples, the displacement operation for the virtual object may be an operation of triggering a displacement shortcut key by the user. The operation of triggering a displacement shortcut key by the user may be a tap operation for the displacement shortcut key. A default displacement direction and a default displacement distance are preset for the displacement shortcut key. Therefore, after triggering the displacement shortcut key, the user controls the virtual object to implement a movement process corresponding to the displacement operation based on a current position of the virtual object in the virtual scene according to the default displacement direction and the default displacement distance. The movement process may also be referred to as a displacement process. The default displacement direction and the default displacement distance may be set by the user according to individual displacement requirements, or may be preset by a game developer. The default displacement direction and the default displacement distance are not limited in this application. For example, the default displacement direction may be a facing direction of the virtual object in the virtual scene, or may be any direction such as a (1, 0) direction, a (1, –1) direction, or a (1, 1) direction based on an origin in a rectangular coordinate system corresponding to the virtual scene. The default displacement distance may be a maximum distance by which the virtual object can release a skill.

In some examples, the displacement operation for the virtual object may be an operation of triggering a distance shortcut key after selecting a displacement direction through a direction-selection control by the user. The operation of selecting a displacement direction through a direction-selection control by the user may be a drag operation for the direction-selection control, and the operation of triggering a distance shortcut key by the user may be a tap operation for the distance shortcut key. A default displacement distance is preset for the distance shortcut key. Therefore, after the user selects a displacement direction based on the origin (the position of the virtual object in the virtual scene) through the direction-selection control, a movement process corresponding to the displacement operation is implemented based on the default displacement distance. The default displacement distance herein may be set by the user according to individual displacement requirements, or may be preset by a game developer. This is not limited in this application. For example, the displacement operation for the virtual object may be a blink movement for the virtual object.

In some examples, the displacement operation for the virtual object may be an operation of triggering a direction shortcut key after selecting a displacement distance through a distance-selection control by the user. The operation of selecting a displacement distance through a distance-selection control by the user may be a drag operation for the distance-selection control, and the operation of triggering a direction shortcut key by the user may be a tap operation for the direction shortcut key. A default displacement direction is preset for the direction shortcut key. Therefore, after the user selects the displacement distance based on the origin through the distance selection control, a movement process corresponding to the displacement operation is implemented according to the default displacement direction. The default displacement direction herein may be set by the user according to individual displacement requirements, or may be preset by a game developer. This is not limited in this application.

In some examples, the displacement operation for the virtual object may be an operation of selecting a displacement direction and a displacement distance through a position-selection control by the user. The operation of selecting a displacement direction and a displacement distance through a position-selection control by the user may be a drag operation for the position-selection control. In some examples, the user may first select a displacement direction based on the origin through the position-selection control, and then select a displacement distance based on the origin. Alternatively, the user may first select a displacement distance based on the origin through the position-selection control, and then select a displacement direction based on the origin. In this way, the movement process corresponding to the displacement operation is implemented.

The displacement direction refers to a direction of the second position relative to the first position. The first position is a start position in the movement process, and the second position is an end position in the movement process. Generally, the first position refers to a current position of the virtual object in the virtual scene, and the second position may be any position in the virtual scene.

The displacement distance mentioned above refers to a linear distance between the first position and the second position. The movement process may be a linear movement process of moving from the first position to the second position, or may be a curved movement process of moving from the first position to the second position. Therefore, the meaning of the displacement distance is different from the meaning of a movement distance of the movement process, and the movement distance of the movement process refers to a total distance of a path traveled by the virtual object in the movement process.

Operation 630: Receive a first skill release operation for the virtual object in the movement process, the first skill release operation being configured for controlling the virtual object to release a directional first skill, and the first skill release operation being received when the virtual object moves to a third position in the virtual scene, the third position being any position in the movement process in which the virtual object moves from the first position to the second position in the virtual scene.

The first skill release operation for the virtual object is received when the virtual object moves to the third position in the virtual scene. The third position is any position in the movement process in which the virtual object moves from the first position to the second position in the virtual scene. For example, the third position is any position on a straight line in the linear movement process in which the virtual object moves from the first position to the second position, or the third position is any position on a curved line in the curved movement process in which the virtual object moves from the first position to the second position. This is not limited in this application. The first skill release operation for the virtual object is an operation triggered by the user for controlling the virtual object to release the first skill.

The first skill is a directional skill. In addition, the first skill is a skill that does not require an instant response, that is, after the user inputs the first skill release operation for the virtual object, the application does not need to immediately release the first skill.

In some examples, if the first skill is a direction-targeted skill, the first skill may be a skill that needs to be released based on a release direction, or may be a skill that needs to be released based on a release direction and a release distance. If the first skill is a skill that needs to be released based on a release direction, the release direction on which the first skill is based may be a direction based on the origin that is selected by the user, or may be a default release direction of the first skill. For example, the default release direction of the first skill may be a facing direction of the virtual object in the virtual scene, or may be a direction of another virtual object associated with the first skill, or may be any direction based on the origin. However, the direction-targeted skill has a preconfigured skill release distance. In other words, for the direction-targeted skill, after a release direction is determined, skill release is performed based on the preconfigured release distance of the skill. If the first skill is a skill that needs to be released based on a release direction and a release distance, the release direction and the release distance on which the first skill is based may be a release direction and a release distance based on the origin that are selected by the user, or may be a default release direction and a default release distance of the first skill.

In some examples, if the first skill is a position-targeted skill, the first skill may be a skill that needs to be released based on a release position in the virtual scene, or may be a skill that needs to be released based on a release position determined based on a release direction and a release distance. If the first skill is a skill that needs to be released based on a release position in the virtual scene, the release position may be a position in the virtual scene that is selected by the user, or may be a default position of the first skill. For example, the default position of the first skill may be a position at which the virtual object initially appears in the virtual scene. If the first skill is a skill that needs to be released based on a release position determined based on a release direction and a release distance, the release position on which the first skill is based may be a release position determined based on a release direction and a release distance that are selected by the user based on the origin.

For example, the direction-targeted skill includes, but is not limited to, at least one of a directional attack-type skill, a directional control-type skill, a displacement-type skill, and a support-type skill. The position-targeted skill includes, but is not limited to, at least one of a displacement-type skill and a position initialization-type skill.

In some examples, the first skill release operation for the virtual object may be an operation of triggering a first skill shortcut key by the user. The operation of triggering a first skill shortcut key by the user may be a tap operation for the first skill shortcut key, or a trigger operation for the first skill shortcut key through an external device. A default release direction and a default release distance of the first skill are preset for the first skill shortcut key. After triggering the first skill shortcut key, the user controls the virtual object to release the first skill based on a current position of the virtual object in the virtual scene according to the default release direction and the default release distance. The default release direction and the default release distance of the first skill are preset by a game developer. For example, the first skill release operation for the virtual object may alternatively be a blink movement for the virtual object, and the virtual object may move by a default release distance corresponding to the blink movement based on the facing direction of the virtual object in the virtual scene. For example, the first skill release operation for the virtual object may be a recall operation for the virtual object, causing the virtual object to return to the position at which the virtual object initially appears in the virtual scene.

In some examples, if the first skill is a direction-targeted skill, the first skill release operation for the virtual object may be an operation of triggering a distance shortcut key after selecting a release direction through a direction-selection control by the user. The operation of selecting a release direction through a direction-selection control by the user may be a drag operation for the direction-selection control, and the operation of triggering a distance shortcut key by the user may be a tap operation for the distance shortcut key. A default release distance is preset for the distance shortcut key. Therefore, after selecting a release direction based on the origin through the direction selection control, the user releases the first skill according to the default release distance. The default release distance of the first skill is preset by a game developer.

In some examples, if the first skill is a position-targeted skill, the first skill release operation for the virtual object may be an operation of selecting a release position through a position-selection control by the user. The operation of selecting a release position through a position-selection control by the user may be a drag operation for the position-selection control, for example, the release direction and the release distance are selected through the drag operation to determine the release position, or may be a tap operation for the position-selection control, for example, the release position is selected through the tap operation.

In some examples, data of the movement process and data of the first skill release operation are stored in the movement process. The data of the movement process includes at least one of the following: the first position, the second position, a movement speed of the virtual object, a movement duration of the movement process, or the movement distance of the movement process. The data of the first skill release operation includes: the third position and operation data of the first skill release operation.

The data of the movement process and data received in the movement process (the data of the first skill release operation) are stored in the movement process through a caching mechanism configured in the game application.

The data of the movement process includes at least one piece of data in the movement process in which the virtual object moves from the first position to the second position in the virtual scene, including at least one of the following: the first position (the start position of the movement process), the second position (the end position of the movement process), the movement speed of the virtual object, the movement duration of the movement process, or the movement distance of the movement process (the total distance of the path traveled in the movement process). The data of the movement process is data obtained based on the displacement operation for the virtual object, the movement speed of the virtual object is determined by the type of the displacement operation, and the movement duration of the movement process and the movement distance of the movement process are determined by the type of the displacement operation and the end position (the second position) of the displacement operation.

The data of the first skill release operation includes the third position and the data of the first skill release operation, and the data of the first skill release operation includes identification data of the first skill and operation data of the first skill release operation. The identification data of the first skill is configured for indicating the first skill, the operation data of the first skill release operation is configured for indicating at least one of an operation direction, an operation distance, or an operation position of the first skill release operation, and the operation data of the first skill release operation is configured for determining a release parameter of the first skill. For a specific process, refer to the following examples.

The data of the movement process and the data of the first skill release operation are stored in the movement process, so that the game application can prevent, based on the data stored in the movement process, the virtual object from releasing other skills in the movement process, and can ensure, based on the data stored in the movement process, that the first skill release operation is responded to when the movement process ends, to implement action connection of the virtual object, to satisfy a game requirement of the user promptly.

In a case that the caching mechanism is configured in the movement process, the virtual object is controlled to release the first skill based on the second position. In a case that no caching mechanism is configured in the movement process, the first skill release operation is not responded to when the movement process ends, that is, the virtual object does not release the first skill when the movement process ends.

Operation 640: Control the virtual object to release the first skill based on the second position.

When the movement process ends, the virtual object is controlled to release the first skill based on the second position, that is, the first skill is an output calculated based on the second position and the input operation (the first skill release operation).

In some examples, the operation of controlling the virtual object to release the first skill based on the second position is performed in a case that the movement process satisfies a condition, that is, operation 640 is performed.

In some examples, the virtual object is controlled to release the first skill based on the third position in a case that the movement process does not satisfy the condition. In other words, the first skill is an output calculated based on the third position and the input operation (the first skill release operation).

Therefore, a difference between this example of this application and the example of the related art lies in that there are no condition limitations in the related art. After the first skill release operation for the virtual object is received, the virtual object is controlled to release the first skill based on the third position when the movement process ends. However, in this example of this application, there are condition limitations. In a case that the movement process satisfies the condition, the virtual object is controlled to release the first skill based on the second position. In a case that the movement process does not satisfy the condition, the virtual object is controlled to release the first skill based on the third position.

The condition in the movement process is configured for determining whether the user can accurately determine the position of the virtual object in the movement process. If the movement process does not satisfy the condition, it indicates that the user cannot accurately determine the position of the virtual object in the movement process. If the movement process satisfies the condition, it indicates that the user can accurately determine the position of the virtual object in the movement process.

The condition limitations are set for the movement process, so that the virtual object is controlled to release the first skill based on the second position only in a case that the user cannot accurately determine the position of the virtual object in the movement process, enabling the output of the game application to better conform to the user's expectation, thereby improving user experience.

In some examples, the condition includes at least one of the following: the movement speed of the virtual object is greater than or equal to a speed threshold; the movement duration of the movement process is less than or equal to a duration threshold; or the movement distance of the movement process is less than or equal to a distance threshold. The speed threshold, the duration threshold, and the distance threshold may be set according to an actual technical requirement.

If the condition includes that the movement speed of the virtual object is greater than or equal to the speed threshold, in a case that the movement process satisfies that the movement speed of the virtual object is greater than or equal to the speed threshold, the virtual object is controlled to release the first skill based on the second position. The virtual object is controlled to release the first skill based on the third position in a case that the movement process satisfies that the movement speed of the virtual object is less than the speed threshold. The movement speed of the virtual object may refer to an average speed of the virtual object in the movement process, or may refer to an instantaneous speed of the virtual object when moving to the third position. If the movement process is a process implemented in response to the operation of variable-speed displacement, the average speed of the virtual object in the movement process is different from the instantaneous speed of the virtual object when moving to the third position. If the movement process is a process implemented in response to the operation of constant-speed displacement, the average speed of the virtual object in the movement process is the same as the instantaneous speed of the virtual object when moving to the third position. For the speed threshold, the speed threshold is threshold data calculated by a game developer based on big data analysis of determining of the position of the virtual object at different speeds in the movement process by the user. This is not limited in this application.

If the condition includes that the movement duration of the movement process is less than or equal to the duration threshold, the virtual object is controlled to release the first skill based on the second position in a case that the movement process satisfies that the movement duration of the movement process is less than or equal to the duration threshold. The virtual object is controlled to release the first skill based on the third position in a case that the movement process satisfies that the movement duration of the movement process is greater than the duration threshold. The movement duration of the movement process is calculated according to the type of the displacement operation and the end position (the second position) of the displacement operation. The movement speed of the virtual object is determined according to the type of the displacement operation. In addition, the movement distance of the movement process is determined according to the type of the displacement operation, the start position (the first position) of the displacement operation, and the end position (the second position) of the displacement operation. The movement duration of the movement process is obtained according to the movement speed of the virtual object and the movement distance of the movement process. For the duration threshold, the duration threshold is threshold data calculated by a game developer based on big data analysis of determining of the position of the virtual object in different durations in the movement process by the user. This is not limited in this application.

If the condition includes that the movement distance of the movement process is less than or equal to the distance threshold, the virtual object is controlled to release the first skill based on the second position in a case that the movement process satisfies that the movement distance of the movement process is less than or equal to the distance threshold. The virtual object is controlled to release the first skill based on the third position in a case that the movement process satisfies that the movement distance of the movement process is greater than the distance threshold. The movement distance of the movement process is calculated according to the type of the displacement operation and the end position (the second position) of the displacement operation. The movement distance of the movement process is determined according to the type of the displacement operation, the start position (the first position) of the displacement operation, and the end position (the second position) of the displacement operation. For the distance threshold, the distance threshold is threshold data calculated by a game developer based on big data analysis of determining of the position of the virtual object at different distances in the movement process by the user. This is not limited in this application.

If the condition includes the foregoing two items, for example, if the condition includes that the movement speed of the virtual object is greater than or equal to the speed threshold and the movement duration of the movement process is less than or equal to the duration threshold, the virtual object is controlled to release the first skill based on the second position in a case that the movement process satisfies that the movement speed of the virtual object is greater than or equal to the speed threshold and the movement duration of the movement process is less than or equal to the duration threshold. The virtual object is controlled to release the first skill based on the third position in a case that the movement process satisfies that the movement speed of the virtual object is less than the speed threshold and the movement duration of the movement process is greater than the duration threshold.

If the condition includes the foregoing three items, the virtual object is controlled to release the first skill based on the second position in a case that the movement process satisfies that the movement speed of the virtual object is greater than or equal to the speed threshold, the movement duration of the movement process is less than or equal to the duration threshold, and the movement distance of the movement process is less than or equal to the distance threshold. The virtual object is controlled to release the first skill based on the third position in a case that the movement process satisfies that the movement speed of the virtual object is less than the speed threshold, the movement duration of the movement process is greater than the duration threshold, and the movement distance of the movement process is greater than the distance threshold.

Threshold determining is performed on the movement speed, the movement duration, and the movement distance in the movement process, so that the game application can intuitively determine, based on the data in the movement process, whether the user can accurately determine the position of the virtual object in the movement process, to determine an output position of the first skill, thereby effectively ensuring skill output accuracy and satisfying a game requirement of the user.

According to the technical solution provided in this example of this application, the virtual object is controlled to release the first skill based on the second position, and the output is calculated according to the end position of the movement process and the input operation in the movement process, so that in a case that the user cannot accurately determine the position of the virtual object when performing the input operation, the first skill finally released is a skill released based on the end position of the movement process, conforming to the user's expectation. Compared with the related art, in which an output is calculated based on a position during an input operation and an input operation in the movement process, which causes a problem of inaccurate skill output, in the technical solution provided in this application, skill release accuracy is improved, thereby improving human-computer interaction efficiency, and the released first skill better conforms to the user's expectation, thereby improving game satisfaction for the user.

In some examples, operation 640 includes at least one of sub-operations 641 and 642 (not shown in the figure).

Sub-operation 641: Determine the release parameter of the first skill based on the second position and the operation data of the first skill release operation.

The operation data of the first skill release operation is configured for indicating at least one of the operation direction, the operation distance, or the operation position of the first skill release operation, and the release parameter of the first skill is configured for indicating at least one of the release direction, the release distance, or the release position of the first skill.

The operation direction of the first skill release operation is configured for determining the release direction of the first skill, and the operation distance of the first skill release operation is configured for determining the release distance of the first skill.

In some examples, the operation position of the first skill release operation may be determined by the release direction and the release distance of the first skill, or may be selected by the user.

The operation position of the first skill release operation is a release position at which the first skill is released based on the third position. The release position of the first skill is determined based on the second position and the operation position of the first skill release operation, that is, the release position at which the first skill is released based on the second position is determined. A relative position between the operation position of the first skill release operation and the third position is the same as a relative position between the release position of the first skill and the second position.

As described above, the operation direction and the operation distance of the first skill release operation may be a default operation direction and a default operation distance that are preset, or at least one of the operation direction or the operation distance may be operation data selected by the user and be related to the first skill release operation for the virtual object. This is not limited in this application.

In some examples, in a case that the first skill is a direction-targeted skill, the release direction of the first skill is determined based on the operation direction of the first skill release operation. The release distance of the first skill is a default release distance preconfigured for the first skill.

In some examples, in a case that the first skill is a direction-targeted skill, the release direction and the release distance of the first skill are determined based on the second position and the operation direction and the operation distance of the first skill release operation.

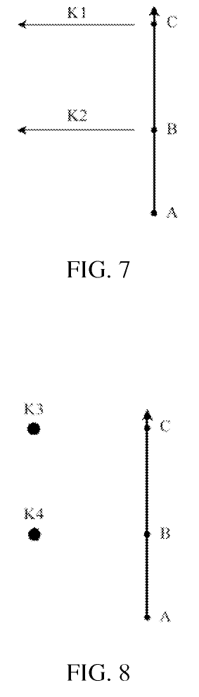

The release direction of the first skill is determined based on the operation direction of the first skill release operation. The release distance of the first skill is determined based on the operation position of the first skill release operation. Referring to FIG. 7, a point A is the start position of the movement process, a point B is a position of the virtual object in the movement process when the user performs the first skill release operation for the virtual object, and a point C is the end position of the movement process. A line K2 is configured for indicating the operation direction and the operation distance of the first skill release operation, and a line K1 is configured for indicating the release direction and the release distance of the first skill. The user performs the first skill release operation for the virtual object at the point B, and when the virtual object reaches the point C, the virtual object is controlled to release the skill indicated by the line K1. It can be seen from FIG. 7 that a relative position between the line K1 and the point C is the same as a relative position between the line K2 and the point B.

In some examples, in a case that the first skill is a position-targeted skill, the release position of the first skill is determined based on the second position and the operation position of the first skill release operation.

Referring to FIG. 8, a point A is the start position of the movement process, a point B is a position of the virtual object in the movement process when the user performs the first skill release operation for the virtual object, and a point C is the end position of the movement process. A point K4 is the operation position of the first skill release operation, a point K3 is the release position of the first skill, and when the virtual object reaches the point C, the virtual object is controlled to release the skill indicated by the point K3. It can be seen from FIG. 8 that a relative position between the point K3 and the point C is the same as a relative position between the point K4 and the point B.

In a case that the first skill is a position-targeted skill, the release position of the first skill is determined based on the second position and the operation position of the first skill release operation, so that the relative position between the release position of the first skill and the second position is the same as the relative position between the operation position of the first skill release operation and the third position, thereby ensuring that the released first skill conforms to the user's expectation when the user inputs the operation, and improving skill release accuracy.

Sub-operation 642: Control, based on the release parameter of the first skill, the virtual object to release the first skill.

In a case that the first skill is a direction-targeted skill, the virtual object may be controlled, based on only the release direction of the first skill, to release the first skill, or the virtual object may be controlled, based on the release direction and the release distance of the first skill, to release the first skill.

In a case that the first skill is a position-targeted skill, the virtual object is controlled, based on the release position of the first skill, to release the first skill.

The operation data of the first skill release operation is obtained, and the release parameter of the first skill is determined with reference to the second position, so that the first skill is a skill that is released based on the second position, thereby effectively ensuring skill release accuracy.

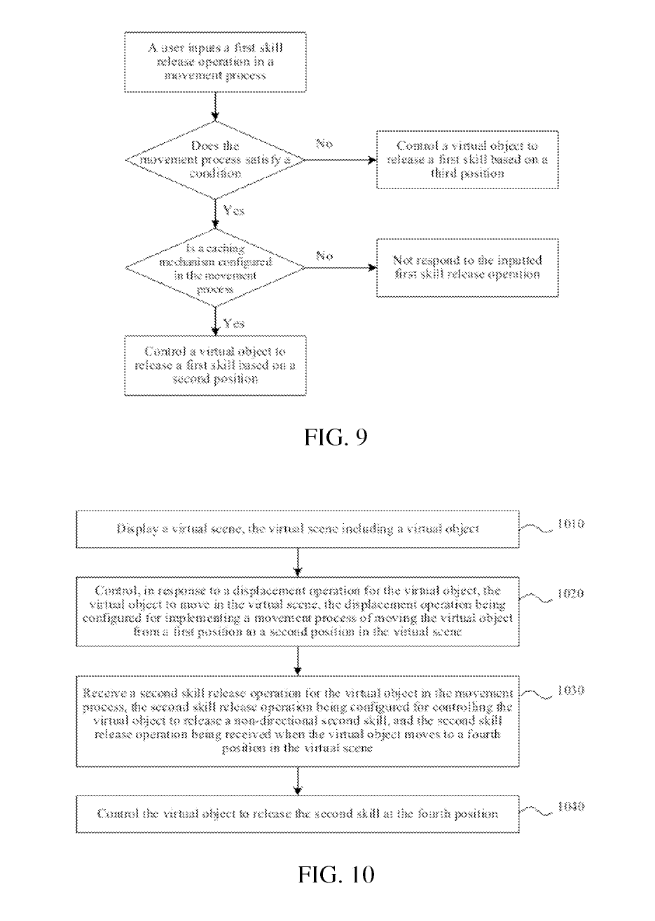

FIG. 9 is a flowchart of output corresponding to a user input operation. The user inputs the first skill release operation in the movement process, and determines whether the movement process satisfies a condition. If the movement process satisfies the condition, whether a caching mechanism is configured in the movement process is determined, and in a case that the caching mechanism is configured in the movement process, the virtual object is controlled to release the first skill based on the second position. In a case that no caching mechanism is configured in the movement process, the inputted first skill release operation is not responded to. If the movement process does not satisfy the condition, the virtual object is controlled to release the first skill based on the third position.

In some examples, the operation of controlling the virtual object to release the first skill based on the second position is performed at a first time point before the virtual object moves to the second position.

A time point at which the virtual object moves to the second position is obtained according to the movement duration of the movement process, and the first time point before the virtual object moves to the second position is determined according to the time point at which the virtual object moves to the second position and a preset time difference.

The time difference is not limited in this application, and is set by a game developer. For example, the time difference may be 0.01 s, so that the first time point before the virtual object moves to the second position may be 0.01 s before the virtual object moves to the second position. The time difference may alternatively be a duration corresponding to two frames, so that the first time point before the virtual object moves to the second position may alternatively be a time point corresponding to two frames before the virtual object moves to the second position. The time difference is less than a first time length. The first time length is not limited in this application. However, from the perspective of the user, at the first time point before the virtual object moves to the second position, the virtual object is controlled to release the first skill based on the second position, and the action of releasing the first skill by the virtual object is directly connected with the movement process of the virtual object, without any pause.

In some examples, the operation of controlling the virtual object to release the first skill based on the second position is performed at a second time point after the virtual object moves to the second position.

A time point at which the virtual object moves to the second position is obtained according to the movement duration of the movement process, and the second time point after the virtual object moves to the second position is determined according to the time point at which the virtual object moves to the second position and a preset time difference.

The time difference is not limited in this application, and is set by a game developer. For example, the time difference may be 0.01 s, so that the second time point after the virtual object moves to the second position may be 0.01 s after the virtual object moves to the second position. The time difference may alternatively be a duration corresponding to two frames, so that the second time point after the virtual object moves to the second position may alternatively be a time point corresponding to two frames after the virtual object moves to the second position. The time difference is less than a second time length. The second time length is not limited in this application. However, from the perspective of the user, at the second time point after the virtual object moves to the second position, the virtual object is controlled to release the first skill based on the second position, and the action of releasing the first skill by the virtual object is directly connected with the movement process of the virtual object, without any pause.

In some examples, the operation of controlling the virtual object to release the first skill based on the second position is performed at a time point at which the virtual object moves to the second position.

The time point at which the virtual object moves to the second position is obtained according to the movement duration of the movement process, and at the time point at which the virtual object moves to the second position, the virtual object is controlled to release the first skill based on the second position.

At the first time point before the virtual object moves to the second position, operation 640 is performed, so that the first skill can be released more promptly. At the second time point after the virtual object moves to the second position, operation 640 is performed, so that the action of the virtual object releasing the first skill can be more naturally connected with the movement process of the virtual object, thereby optimizing a skill response effect, improving operation feel, and improving user experience.

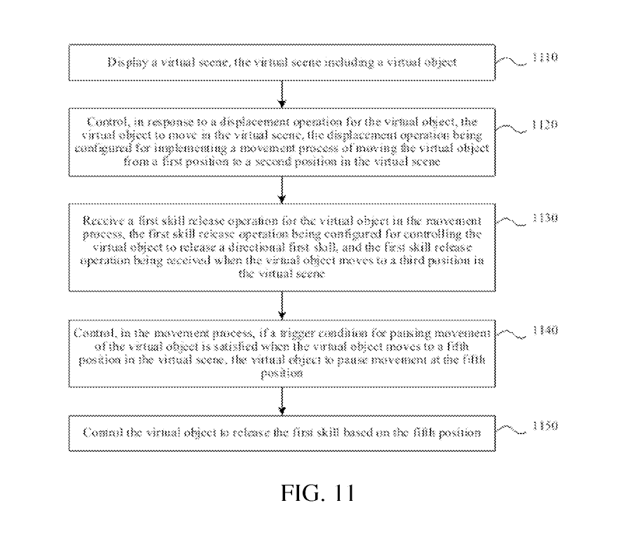

FIG. 10 is a flowchart of a virtual object control method according to another example of this application. Operations of the method may be performed by a terminal device. The method may include at least one of the following operations 1010 to 1040.

Operation 1010: Display a virtual scene, the virtual scene including a virtual object.

Operation 1020: Control, in response to a displacement operation for the virtual object, the virtual object to move in the virtual scene, the displacement operation being configured for implementing a movement process of moving the virtual object from a first position to a second position in the virtual scene.

Operation 1030: Receive a second skill release operation for the virtual object in the movement process, the second skill release operation being configured for controlling the virtual object to release a non-directional second skill, and the second skill release operation being received when the virtual object moves to a fourth position in the virtual scene.

The second skill release operation for the virtual object is received when the virtual object moves to the fourth position in the virtual scene. The fourth position is any position in the movement process in which the virtual object moves from the first position to the second position in the virtual scene. For example, the fourth position is any position on a straight line in the linear movement process in which the virtual object moves from the first position to the second position, or the fourth position is any position on a curved line in the curved movement process in which the virtual object moves from the first position to the second position. This is not limited in this application. The fourth position may be different from the third position. The second skill release operation for the virtual object is an operation triggered by the user for controlling the virtual object to release the second skill.

The second skill is a non-directional skill. To be specific, it indicates that the second skill is a skill that does not need to be released based on a release direction. The second skill is a skill that requires an instant response. In other words, after the user inputs the second skill release operation for the virtual object, the application needs to immediately release the second skill. For example, the second skill includes, but is not limited to, at least one of the following: a skill that restores health points of the virtual object, a non-directional attack-type skill, or a non-directional control-type skill.

Generally, the second skill release operation for the virtual object is an operation of triggering a second skill shortcut key by the user. The operation of triggering a second skill shortcut key by the user is a tap operation for the second skill shortcut key.

In some examples, in the movement process, data of the second skill release operation is stored. The data of the second skill release operation includes the fourth position and operation data of the second skill release operation, and the operation data of the second skill release operation includes identification data of the second skill and effect data of the second skill.

Operation 1040: Control the virtual object to release the second skill at the fourth position.

When the virtual object moves to the fourth position in the virtual scene, in response to the second skill release operation for the virtual object, the virtual object is controlled to release the second skill at the fourth position.

By instantly responding to the non-directional second skill, the virtual object is controlled to release the second skill at the fourth position, so that the release of the second skill can satisfy a skill release requirement of the user, thereby ensuring skill release accuracy and improving operation feel.

FIG. 11 is a flowchart of a virtual object control method according to another example of this application. Operations of the method may be performed by a terminal device. The method may include at least one of the following operations 1110 to 1150.

Operation 1110: Display a virtual scene, the virtual scene including a virtual object.

Operation 1120: Control, in response to a displacement operation for the virtual object, the virtual object to move in the virtual scene, the displacement operation being configured for implementing a movement process of moving the virtual object from a first position to a second position in the virtual scene.

Operation 1130: Receive a first skill release operation for the virtual object in the movement process, the first skill release operation being configured for controlling the virtual object to release a directional first skill, and the first skill release operation being received when the virtual object moves to a third position in the virtual scene.

Operation 1140: Control, in the movement process, if a trigger condition for pausing movement of the virtual object is satisfied when the virtual object moves to a fifth position in the virtual scene, the virtual object to pause movement at the fifth position.

The fifth position is any position in a process in which the virtual object continues to move from the third position to the second position in the virtual scene. For example, the fifth position is any position on a straight line in the linear movement process in which the virtual object continues to move from the third position to the second position, or the fifth position is any position on a curved line in the curved movement process in which the virtual object moves from the third position to the second position. This is not limited in this application.

The trigger condition for pausing movement of the virtual object is configured for forcing the virtual object to pause the movement process in the virtual scene, that is, it indicates that after the trigger condition for pausing movement of the virtual object is satisfied, the virtual object will pause at the fifth position in the virtual scene.

The trigger condition for pausing movement of the virtual object is that another virtual object releases a pause skill for the virtual object, and the virtual object pauses movement at the fifth position according to the pause skill. The pause skill released by the another virtual object for the virtual object is configured for controlling the virtual object to pause movement at the fifth position for a period of time. For example, the pause skill released by the another virtual object for the virtual object may be a freezing skill.

Operation 1150: Control the virtual object to release the first skill based on the fifth position.

The first skill herein is an output calculated based on the fifth position and the input operation (the first skill release operation). A relative position between a release parameter of the first skill and the fifth position is the same as a relative position between operation data of the first skill release operation and the third position.

In some examples, the operation of controlling the virtual object to release the first skill based on the fifth position is performed at the end of a first duration after a start moment at which the virtual object pauses movement.

In other words, the pause skill released by the another virtual object for the virtual object is configured for controlling the virtual object to pause movement at the fifth position for the first duration.

In some examples, operation 1150 may be performed at a first time point before the end of the first duration after the start moment at which the virtual object pauses movement. Alternatively, operation 1150 may be performed at a second time point after the end of the first duration after the start moment at which the virtual object pauses movement. Alternatively, operation 1150 may be performed at a time point at the end of the first duration after the start moment at which the virtual object pauses movement.

Operation 1150 is performed at the end of the first duration after the start moment at which the virtual object pauses movement, so that the virtual object may promptly respond to the first skill release operation after stopping pausing, thereby reducing a possibility that the virtual object continues to be attacked by other virtual objects, improving richness of the game, and attracting the user's attention to the game program.

In some examples, if no skill release operation for the virtual object is received after the first skill release operation is received and before the end of the first duration, operation 1150 is performed at the end of the first duration.

In some examples, if a third skill release operation for the virtual object is received after the first skill release operation is received and before the end of the first duration, the virtual object is controlled to release a third skill based on the fifth position. The third skill release operation is configured for controlling the virtual object to release a directional or non-directional third skill.

In other words, if the virtual object is controlled to pause movement at the fifth position in a case that the trigger condition for pausing movement of the virtual object is satisfied, the virtual object is controlled to respond, based on the fifth position, to the latest received skill release operation at the end of the first duration.

If the latest skill release operation is the first skill release operation received when the virtual object moves to the third position in the virtual scene, the virtual object is controlled to release the first skill based on the fifth position at the end of the first duration after the start moment at which the virtual object pauses movement.

If the latest skill release operation is the third skill release operation for the virtual object received after the first skill release operation is received and before the end of the first duration, the virtual object is controlled to release the third skill based on the fifth position at the end of the first duration after the start moment at which the virtual object pauses movement.

The third skill release operation for the virtual object may be any skill release operation for the virtual object. This is not specifically limited in this application.

A running mechanism of the game is enriched by using the foregoing method, thereby enhancing interest and attention of the user to the game, and improving user experience.

The following describes apparatus examples of this application, which can be configured for performing the method examples of this application. For details not disclosed in the apparatus examples of this application, refer to the method examples of this application.

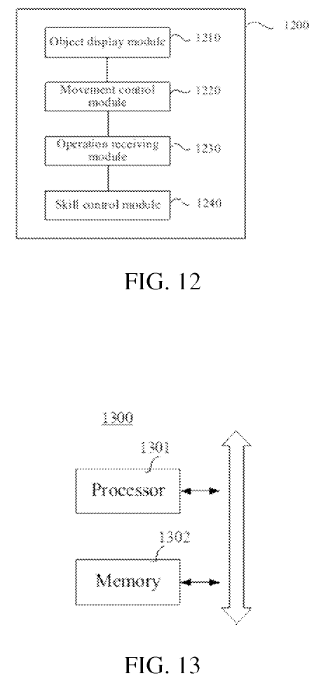

FIG. 12 is a block diagram of a virtual object control apparatus according to an example of this application. The apparatus has functions for implementing the foregoing virtual object control method. The functions may be implemented by hardware, or may be implemented by hardware executing corresponding software. The apparatus may be the terminal device described above, or may be disposed in a terminal device. As shown in FIG. 12, the apparatus 1200 may include: an object display module 1210, a movement control module 1220, an operation receiving module 1230, and a skill control module 1240.

The object display module 1210 is configured to display a virtual scene, the virtual scene including a virtual object.

The movement control module 1220 is configured to control, in response to a displacement operation for the virtual object, the virtual object to move in the virtual scene, the displacement operation being configured for implementing a movement process of moving the virtual object from a first position to a second position in the virtual scene.

The operation receiving module 1230 is configured to receive a first skill release operation for the virtual object in the movement process, the first skill release operation being configured for controlling the virtual object to release a directional first skill, and the first skill release operation being received when the virtual object moves to a third position in the virtual scene, the third position being any position in the movement process in which the virtual object moves from the first position to the second position in the virtual scene.

The skill control module 1240 is configured to control the virtual object to release the first skill based on the second position.

In some examples, the skill control module 1240 is configured to: perform, in a case that the movement process satisfies a condition, the operation of controlling the virtual object to release the first skill based on the second position.

In some examples, the condition includes at least one of the following: a movement speed of the virtual object is greater than or equal to a speed threshold; a movement duration of the movement process is less than or equal to a duration threshold; or a movement distance of the movement process is less than or equal to a distance threshold.

In some examples, the skill control module 1240 is configured to: control, in a case that the movement process does not satisfy the condition, the virtual object to release the first skill based on the third position.

In some examples, the skill control module 1240 is configured to: determine a release parameter of the first skill based on the second position and operation data of the first skill release operation, the operation data of the first skill release operation being configured for indicating at least one of an operation direction, an operation distance, or an operation position of the first skill release operation, and the release parameter of the first skill being configured for indicating at least one of a release direction, a release distance, or a release position of the first skill; and control, based on the release parameter of the first skill, the virtual object to release the first skill.

In some examples, the skill control module 1240 is configured to: determine, in a case that the first skill is a direction-targeted skill, the release direction and the release distance of the first skill based on the second position and the operation direction and the operation distance of the first skill release operation; or determine, in a case that the first skill is a position-targeted skill, the release position of the first skill based on the second position and the operation position of the first skill release operation.

In some examples, the apparatus 1200 further includes a data storage module. The data storage module is configured to:

store data of the movement process and data of the first skill release operation in the movement process, the data of the movement process including at least one of the following: the first position, the second position, the movement speed of the virtual object, the movement duration of the movement process, or the movement distance of the movement process; and the data of the first skill release operation including: the third position and the data of the first skill release operation.

In some examples, the skill control module 1240 is configured to: perform, at a first time point before the virtual object moves to the second position, the operation of controlling the virtual object to release the first skill based on the second position; or perform, at a second time point after the virtual object moves to the second position, the operation of controlling the virtual object to release the first skill based on the second position; or perform, at a time point at which the virtual object moves to the second position, the operation of controlling the virtual object to release the first skill based on the second position.

In some examples, the operation receiving module 1230 is configured to receive a second skill release operation for the virtual object in the movement process, the second skill release operation being configured for controlling the virtual object to release a non-directional second skill, and the second skill release operation being received when the virtual object moves to a fourth position in the virtual scene, the fourth position being any position in the movement process in which the virtual object moves from the first position to the second position in the virtual scene.

The skill control module 1240 is configured to control the virtual object to release the second skill at the fourth position.

In some examples, the apparatus 1200 further includes a pause control module. The pause control module is configured to: control, in the movement process, if a trigger condition for pausing movement of the virtual object is satisfied when the virtual object moves to a fifth position in the virtual scene, the virtual object to pause movement at the fifth position, the fifth position being any position in a process in which the virtual object continues to move from the third position to the second position in the virtual scene; and control the virtual object to release the first skill based on the fifth position.

In some examples, the pause control module is configured to: perform the operation of controlling the virtual object to release the first skill based on the fifth position at the end of a first duration after a start moment at which the virtual object pauses movement.

In some examples, the pause control module is configured to: perform, if no skill release operation for the virtual object is received after the first skill release operation is received and before the end of the first duration, the operation of controlling the virtual object to release the first skill based on the fifth position at the end of the first duration; or control, if a third skill release operation for the virtual object is received after the first skill release operation is received and before the end of the first duration, the virtual object to release a third skill based on the fifth position, the third skill release operation being configured for controlling the virtual object to release a directional or non-directional third skill.

When the apparatus provided in the foregoing examples implements functions of the apparatus, it is illustrated with an example of division of each functional module. In the practical application, the function distribution may be finished by different functional modules according to the requirements, that is, the internal structure of the device is divided into different functional modules, to implement all or some of the functions described above. In addition, the apparatus and method examples provided in the foregoing examples are based on the same concept. For details of a specific implementation process of the apparatus, refer to the method examples. Details are not described herein again.

FIG. 13 is a structural block diagram of a computer device 1300 according to an example of this application. The computer device 1300 may be any electronic device having data calculation, processing, and storage functions. The computer device 1300 may be configured to implement the virtual object control method provided in the foregoing examples. The computer device 1300 may be a terminal device.

Generally, the computer device 1300 includes: a processor 1301 and a memory 1302.

The processor 1301 may include one or more processing cores, for example, a 4-core processor or an 8-core processor. The processor 1301 may be implemented in at least one hardware form of a digital signal processor (DSP), a field-programmable gate array (FPGA), and a programmable logic array (PLA). The processor 1301 may also include a main processor and a co-processor. The main processor is a processor configured to process data in an awake state, and is also referred to as a central processing unit (CPU). The co-processor is a low-power consumption processor configured to process data in a standby state. In some examples, the processor 1301 may be integrated with a graphics processing unit (GPU), and the GPU is configured to be responsible for rendering and drawing content to be displayed on a display screen. In some examples, the processor 1301 may further include an artificial intelligence (AI) processor. The AI processor is configured to process calculation operations related to machine learning.

The memory 1302 may include one or more computer-readable storage media. The computer-readable storage medium may be non-transitory. The memory 1302 may further include a high-speed random access memory and a non-volatile memory, for example, one or more disk storage devices or flash memory storage devices. In some examples, the non-transitory computer-readable storage medium in the memory 1302 is configured to store a computer program, and the computer program is configured to be executed by one or more processors, to implement the foregoing virtual object control method.

A person skilled in the art may understand that the structure shown in FIG. 13 does not constitute any limitation on the computer device 1300, and the computer device 1300 may include more components or fewer components than those shown in the figure, or combine some components, or use a different component arrangement.

In an example, a computer-readable storage medium is further provided. The storage medium has a computer program stored therein, the computer program, when executed by a processor of a computer device, implementing the foregoing virtual object control method. In some examples, the computer-readable storage medium may be a read-only memory (ROM), a random access memory (RAM), a compact disc read-only memory (CD-ROM), a magnetic tape, a floppy disk, an optical data storage device, or the like.

In an example, a computer program product is further provided. The computer program product includes a computer program. The computer program is stored in a computer-readable storage medium. A processor of a computer device reads the computer program from the computer-readable storage medium, and the processor executes the computer program, so that the computer device performs the virtual object control method.

In this application, before related data of a user is collected and in a process of collecting the related data of the user, a prompt interface and a pop-up window may be displayed, or voice prompt information may be outputted. The prompt interface, the pop-up window, or the voice prompt information is configured for prompting the user that the related data of the user is being collected. Therefore, in this application, only after a confirmation operation initiated by the user for the prompt interface or the pop-up window is obtained, a related operation of obtaining the related data of the user starts to be performed. Otherwise (in other words, when the confirmation operation initiated by the user for the prompt interface or the pop-up window is not obtained), the related operation of obtaining the related data of the user ends, that is, the related data of the user is not obtained. In other words, all user data collected in this application is strictly processed according to the requirements of relevant national laws and regulations, and an informed consent or an individual consent of a personal information subject is collected with consent and authorization of the user. Within the scope of laws, regulations, and the authorization of the personal information subject, the subsequent use and processing of data and the collection, use and processing of relevant user data need to comply with the relevant laws, regulations, and standards of relevant countries and regions.

"A plurality of" mentioned herein refers to two or more. "And/or" describes an association relationship between associated objects and indicates that three relationships may exist. For example, A and/or B may indicate the following three cases: A exists alone, both A and B exist, and B exists alone. The character "/" generally indicates an "or" relationship between associated objects in the context. In addition, the operation numbers described in this specification merely show a possible execution sequence of the operations. In some other examples, the foregoing operations may not be performed based on the number sequence. For example, two operations with different numbers may be performed simultaneously, or two operations with different numbers may be performed based on a sequence contrary to the sequence shown in the figure. This is not limited in the examples of this application.

The above descriptions are merely examples of this application, but are not intended to limit this application. Any modification, equivalent replacement, improvement, and the like made within the spirit and principle of this application are included within the protection scope of this application.

What is claimed is:

1. A virtual object control method, performed by a computing device, the method comprising: displaying a virtual scene, the virtual scene comprising a virtual object;controlling, in response to a displacement operation for the virtual object, the virtual object to move in the virtual scene, the displacement operation being configured for implementing a movement process of moving the virtual object from a first position to a second position in the virtual scene; receiving a first skill release operation for the virtual object in the movement process, the first skill release operation being configured for controlling the virtual object to release a directional first skill, and the first skill release operation being received when the virtual object moves to a third position in the virtual scene, the third position being a position in the movement process in which the virtual object moves from the first position to the second position in the virtual scene; and controlling the virtual object to release the first skill based on the second position.

2. The method according to claim 1, further comprising: controlling , based on the movement process satisfying a condition, the virtual object to release the first skill based on the second position.

3. The method according to claim 2, wherein the condition comprises at least one of the following: a movement speed of the virtual object is greater than or equal to a speed threshold; a movement duration of the movement process is less than or equal to a duration threshold; or a movement distance of the movement process is less than or equal to a distance threshold.

4. The method according to claim 2, further comprising: controlling, based on the movement process does not satisfying the condition, the virtual object to release the first skill based on the third position.

5. The method according to claim 1, wherein the controlling the virtual object to release the first skill based on the second position comprises:determining a release parameter of the first skill based on the second position and operation data of the first skill release operation, the operation data of the first skill release operation being configured for indicating at least one of an operation direction, an operation distance, or an operation position of the first skill release operation, and the release parameter of the first skill being configured for indicating at least one of a release direction, a release distance, or a release position of the first skill; andcontrolling, based on the release parameter of the first skill, the virtual object to release the first skill.

6. The method according to claim 5, wherein the determining the release parameter of the first skill based on the second position and operation data of the first skill release operation comprises: determining, based on the first skill being a direction-targeted skill, the release direction and the release distance of the first skill based on the second position and the operation direction and the operation distance of the first skill release operation; ordetermining, based on the first skill being a position-targeted skill, the release position of the first skill based on the second position and the operation position of the first skill release operation.

7. The method according to claim 1, further comprising: storing data of the movement process and data of the first skill release operation in the movement process, the data of the movement process comprising at least one of the following: the first position, the second position, a movement speed of the virtual object, a movement duration of the movement process, or a movement distance of the movement process; and the data of the first skill release operation comprising: the third position and operation data of the first skill release operation.

8. The method according to claim 1, further comprising: controlling, at a first time point before the virtual object moves to the second position, the virtual object to release the first skill based on the second position; controlling, at a second time point after the virtual object moves to the second position, the virtual object to release the first skill based on the second position; or controlling, at a time point at which the virtual object moves to the second position, the virtual object to release the first skill based on the second position.

9. The method according to claim 1, further comprising: receiving, when the virtual object moves to a fourth position in the virtual scene, a second skill release operation for the virtual object in the movement process, the second skill release operation being configured for controlling the virtual object to release a non-directional second skill, the fourth position being another position in the movement process in which the virtual object moves from the first position to the second position in the virtual scene; and controlling the virtual object to release the second skill at the fourth position.

10. The method according to claim 1, wherein after the receiving a first skill release operation for the virtual object, the method further comprises: controlling, in the movement process, if a trigger condition for pausing movement of the virtual object is satisfied when the virtual object moves to a fifth position in the virtual scene, the virtual object to pause movement at the fifth position, the fifth position being another position in a process in which the virtual object continues to move from the third position to the second position in the virtual scene; and controlling the virtual object to release the first skill based on the fifth position.

11. The method according to claim 10, further comprising: controlling the virtual object to release the first skill based on the fifth position at an end of a first duration after a start moment at which the virtual object pauses movement.

12. The method according to claim 11, further comprising: controlling, if no skill release operation for the virtual object is received after the first skill release operation is received and before the end of the first duration, the virtual object to release the first skill based on the fifth position at the end of the first duration; or controlling, if a third skill release operation for the virtual object is received after the first skill release operation is received and before the end of the first duration, the virtual object to release a third skill based on the fifth position, the third skill release operation being configured for controlling the virtual object to release a directional or non-directional third skill.

13. A virtual object control apparatus, comprising: one or more processors; and memory storing instructions that, when executed by the one or more processors, cause the virtual object control apparatus to: display a virtual scene, the virtual scene comprising a virtual object; control, in response to a displacement operation for the virtual object, the virtual object to move in the virtual scene, the displacement operation being configured for implementing a movement process of moving the virtual object from a first position to a second position in the virtual scene; receive a first skill release operation for the virtual object in the movement process, the first skill release operation being configured for controlling the virtual object to release a directional first skill, and the first skill release operation being received when the virtual object moves to a third position in the virtual scene, the third position being a position in the movement process in which the virtual object moves from the first position to the second position in the virtual scene; and control the virtual object to release the first skill based on the second position.

14. The virtual object control apparatus according to claim 13, wherein the instructions, when executed by the one or more processors, cause the virtual object control apparatus to: perform, based on the movement process satisfying a condition, the operation of controlling the virtual object to release the first skill based on the second position.

15. The virtual object control apparatus according to claim 14, wherein the condition comprises at least one of the following:
a movement speed of the virtual object is greater than or equal to a speed threshold;
a movement duration of the movement process is less than or equal to a duration threshold; or
a movement distance of the movement process is less than or equal to a distance threshold.

16. The virtual object control apparatus according to claim 13, wherein the instructions, when executed by the one or more processors, cause the virtual object control apparatus to: determine a release parameter of the first skill based on the second position and operation data of the first skill release operation, the operation data of the first skill release operation being configured for indicating at least one of an operation direction, an operation distance, or an operation position of the first skill release operation, and the release parameter of the first skill being configured for indicating at least one of a release direction, a release distance, or a release position of the first skill; and control, based on the release parameter of the first skill, the virtual object to release the first skill.

17. A non-transitory computer-readable storage medium storing instructions that, when executed by a processor, cause a computer device to: display a virtual scene, the virtual scene comprising a virtual object; control, in response to a displacement operation for the virtual object, the virtual object to move in the virtual scene, the displacement operation being configured for implementing a movement process of moving the virtual object from a first position to a second position in the virtual scene; receive a first skill release operation for the virtual object in the movement process, the first skill release operation being configured for controlling the virtual object to release a directional first skill, and the first skill release operation being received when the virtual object moves to a third position in the virtual scene, the third position being a position in the movement process in which the virtual object moves from the first position to the second position in the virtual scene; and control the virtual object to release the first skill based on the second position.

18. The non-transitory computer-readable storage medium according to claim 17, wherein the instructions, when executed by the processor, cause the computer device to control, based on the movement process satisfying a condition, the virtual object to release the first skill based on the second position.

19. The non-transitory computer-readable storage medium according to claim 18, wherein the condition comprises at least one of the following: a movement speed of the virtual object is greater than or equal to a speed threshold; a movement duration of the movement process is less than or equal to a duration threshold; or
a movement distance of the movement process is less than or equal to a distance threshold.

20. The non-transitory computer-readable storage medium according to claim 17, wherein the instructions, when executed by the processor, cause the computer device to:
determine a release parameter of the first skill based on the second position and operation data of the first skill release operation, the operation data of the first skill release operation being configured for indicating at least one of an operation direction, an operation distance, or an operation position of the first skill release operation, and the release parameter of the first skill being configured for indicating at least one of a release direction, a release distance, or a release position of the first skill; and control, based on the release parameter of the first skill, the virtual object to release the first skill.
